(19) United States
(12) Patent Application Publication
(10) Pub. No.: US 2026/0208900 A1
(43) Pub. Date: Jul. 23, 2026

(54) TRANSFER DEVICE AND METHOD FOR TRANSFERRING GOODS

(71) Applicant: TGW Logistics GmbH, Marchtrenk (AT)

(72) Inventors: Stefan HOLZNER, Zaisering (DE); Florian FORSTER, Bad Endorf (DE); Sebastian MEYRL, Neubeuern (DE)

(73) Assignee: TGW Logistics GmbH, Marchtrenk (AT)

(21) Appl. No.: 19/135,865

(22) PCT Filed: Dec. 7, 2023
(86) PCT No.: PCT/AT2023/060433

§ 371 Date: Jun. 5, 2025

(30) Foreign Application Priority Data
Dec. 9, 2022 (AT) A50940/2022

(51) Int. Cl. B65B 35/32; B65B 69/00; B65G 1/137; B65G 65/23

(52) U.S. Cl. CPC B65B 35/32; B65B 69/00; B65G 65/23; B65G 1/1376

(57) ABSTRACT

A transfer device for reloading articles from a dispensing container into a receiving container includes a first provisioning device, a second provisioning device, a transfer container and a container manipulation device. The transfer device is configured to put the transfer container over the dispensing container in order to transfer the article from the dispensing container into the transfer container. Furthermore, the transfer device is configured to tip the transfer container in order to transfer the article from the transfer container into the receiving container. Moreover, a corresponding method uses and an order-picking system has such a transfer device.

The invention relates to a transfer device for reloading articles from a dispensing container, in particular from a crate or a box, into a receiving container, in particular into a shipping box or shipping bag, comprising a first provisioning device with a first provisioning location for the provision of a dispensing container, a second provisioning device with a second provisioning location for the provision of a receiving container, a transfer container for the interim receipt of the article, and a container manipulation device for handling the transfer container and the dispensing container.

Furthermore, the invention relates to a method for reloading articles from a dispensing container into a receiving container using a transfer device, in particular using such a transfer device.

Moreover, the invention relates to an order-picking system for picking articles according to picking orders, comprising an article storage for storing articles, a picking station for reloading articles from storage containers into dispensing containers, in particular picking containers, a transfer device for reloading articles from dispensing containers into receiving containers, in particular shipping containers, an automatic first conveying device for transporting storage containers from the article storage to the picking station, an automatic second conveying device for transporting empty dispensing containers to the picking station, and an automatic third conveying device for transporting dispensing containers loaded with articles from the picking station to the transfer device.

In an order-picking system, it often necessary for articles of an order to be picked in that they are collated in a picking container according to an order at a picking station.

To prepare the order for shipping, it can be provided that the article is to be reloaded from the picking container, which remains in the shipping storage, into a shipping bag. The picking container thereby constitutes the dispensing container and the shipping bag the receiving container. The reloading of the article into the shipping bag is often performed manually. However, devices and methods which enable an automatic filling of a shipping bag are known in the prior art.

For example, US 2014/116013 A1 discloses a device and a method for reloading articles from a dispensing container into a shipping bag, wherein the articles are dispensed from above into a transfer container. The transfer container comprises two chambers each with a hinged base and a shaft between the chambers. For instance, documents can be pushed through the shaft and directly dispensed into a shipping bag spread beneath the transfer container. Surplus articles can be filled into the chambers and dispensed into the shipping bag by opening the base.

CN 212738571 U describes a device and a method for reloading articles from a dispensing container into a shipping bag, wherein the dispensing container is lifted and tipped using a lifting and tipping mechanism such that the articles are emptied out through an opened upper side of the dispensing container and filled into a collection hopper. The articles are dispensed through the collection hopper onto a vibrating filling mechanism. The articles are transported using the filling mechanism from the collection hopper to a weighing and filling hopper and filled into a shipping bag by the latter.

A device and a method for the automatic packaging of articles is known from WO 2020/140133A2, wherein articles are dispensed from transport bags onto a bottom shelf. An article stack is thereby formed on the bottom shelf. Once the article stack has been formed, the bottom shelf can be titled such that the article stack slides into an adjacent spread shipping bag.

Furthermore, various embodiments of a transfer device and of a method for reloading articles from a dispensing container into a receiving container are known from US 2021/0101759A1, U.S. Pat. No. 11,104,527 B1 and US 2002/0146308A1.

One object of the invention is to create an improved transfer device as well as an improved method for reloading articles from a dispensing container into a receiving container. In particular, automatic reloading as well as the use of conventional crates or boxes as dispensing containers ought to be possible.

A further object of the invention is to create an improved order-picking system.

The object is solved by a transfer device of the type mentioned at the beginning, wherein the transfer container has a base, a receiving opening opposite the base, side walls protruding from the base and delimiting the receiving opening, and a dispensing opening, and wherein the container manipulation device is configured to put the transfer container, in particular with its receiving opening, over a dispensing container containing articles provided by the first provisioning device and to turn the transfer container together with the dispensing container such that the article is dispensed from the dispensing container into the transfer container.

Furthermore, the container manipulation device is configured to remove the dispensing container from the transfer container and to move, in particular to tilt, the transfer container such that the article is emptied from, in particular tipped out of, the transfer container, and is dispensed into a receiving container provided by the second provisioning device.

Moreover, the object is solved by a method of the type mentioned at the beginning, which comprises the following steps:
i) providing a dispensing container containing an article, in particular a previously picked ordered article, at the transfer device using a first provisioning device at a first provisioning location;
ii) putting a transfer container, in particular with its receiving opening, over the provided dispensing container using a container manipulation device, in particular using a first container manipulation unit of the container manipulation device;
iii) turning the transfer container together with the dispensing container using the container manipulation device, in particular using the first container manipulation unit of the container manipulation device, wherein the article is dispensed from the dispensing container into the transfer container;
iv) removing the dispensing container from the transfer container using the container manipulation device, in particular using a second container manipulation unit of the container manipulation device;
v) providing a receiving container at the transfer device using a second provisioning device at a second provisioning location;
vi) positioning the transfer container using the container manipulation device, in particular using the first container manipulation unit of the container manipulation device, such that the article is emptied from, in particular tipped out of, the transfer container through a dispensing opening of the transfer container, and is dispensed into the receiving container.

One advantage achieved by the invention is in particular that a refilling of articles from the dispensing container into the transfer container and further into the receiving container, in particular a shipping bag, can be performed fully automatically, wherein conventional crates or boxes can be used as dispensing containers. The article here comprises in particular one or more items.

In particular, the emptying and dispensing of the article according to step vi) can be performed by gravity alone.

It is advantageously provided that the dispensing container is provided as a crate, in particular as a plastic crate. Articles can thus be loaded into the dispensing container in a simple manner and be transported with the dispensing container using an automatic conveying device. The dispensing container customarily comprises a base, (four) side walls protruding from the base, as well as a side opposite the base on which a receiving opening delimited by the side walls is arranged. The dispensing container is preferably a pre-picked container with an article, in particular an ordered article. For this purpose, the article can, for example, be loaded into the dispensing container at a picking station according to a picking order. The dispensing container is preferably transportable using a conveying device.

It is expedient if the transfer device comprises one or more dispensing containers. The transfer container comprises a base that substantially forms a placement surface for the article, and side walls protruding from the base. The article is secured in the transfer container by the side walls. For example, the transfer container can comprise at least two side walls, in particular three side walls. The dispensing opening allows for the article to be dispensed from the transfer container.

The side walls preferably comprise two opposite longitudinal walls that each extend along a longitudinal side of the transfer container, in particular parallel to a longitudinal center plane of the transfer container. Furthermore, the side walls can comprise a transverse side wall that extends along a transverse side of the transfer container, in particular parallel to a transverse center plane of the transfer container. Optionally, the side walls comprise an additional transverse side wall opposite the transverse side wall that also extends along a transverse side of the transfer container, in particular parallel to a transverse center plane of the transfer container.

The longitudinal center plane can thereby extend in the longitudinal direction of the transfer container through a geometric center point of the base of the transfer container. Equally, the transverse center plane can extend in the transverse direction of the transfer container through the geometric center point of the base of the transfer container. The longitudinal center plane and the transverse center plane are aligned orthogonally to one another and orthogonally to the base of the transfer container.

It is expedient if the dispensing opening extends along a transverse side of the transfer container, in particular parallel to the transverse center plane. The dispensing opening is preferably arranged between the opposing longitudinal side walls, for example instead of the additional transverse side wall or in the additional transverse side wall.

As described, the transfer container can be put, in particular with its dispensing opening, over a dispensing container.

An inner dimension of the transfer container can be selected in such a way that the dispensing container is arranged between two opposing longitudinal side walls of the side walls when the transfer container is put over the dispensing container.

An inner dimension of the transfer container can be selected in such a way that the dispensing container is arranged between two opposing transverse side walls of the side walls or between a transverse side wall of the side walls and a dispensing opening when the transfer container is put over the dispensing container.

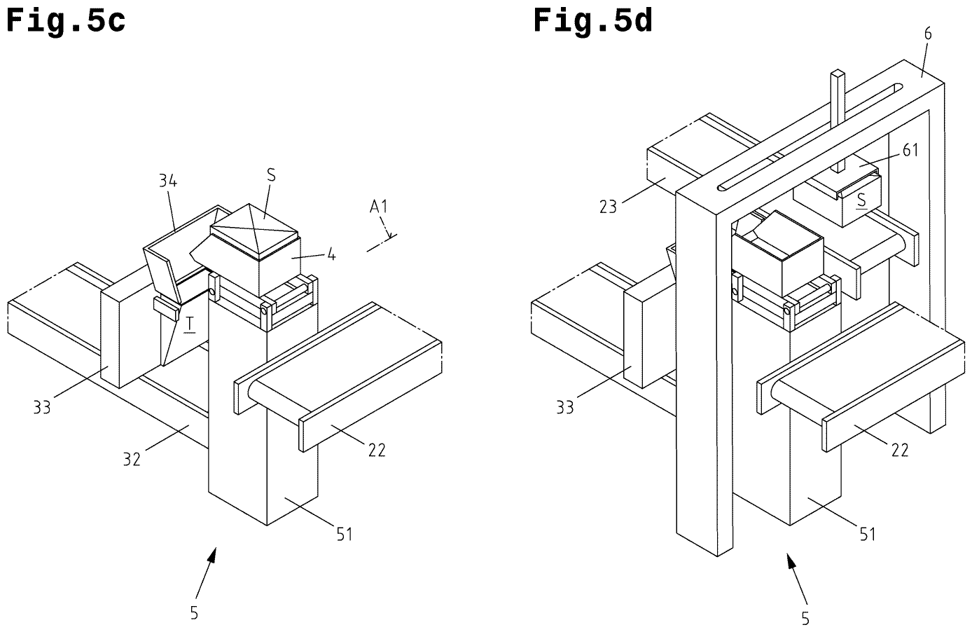

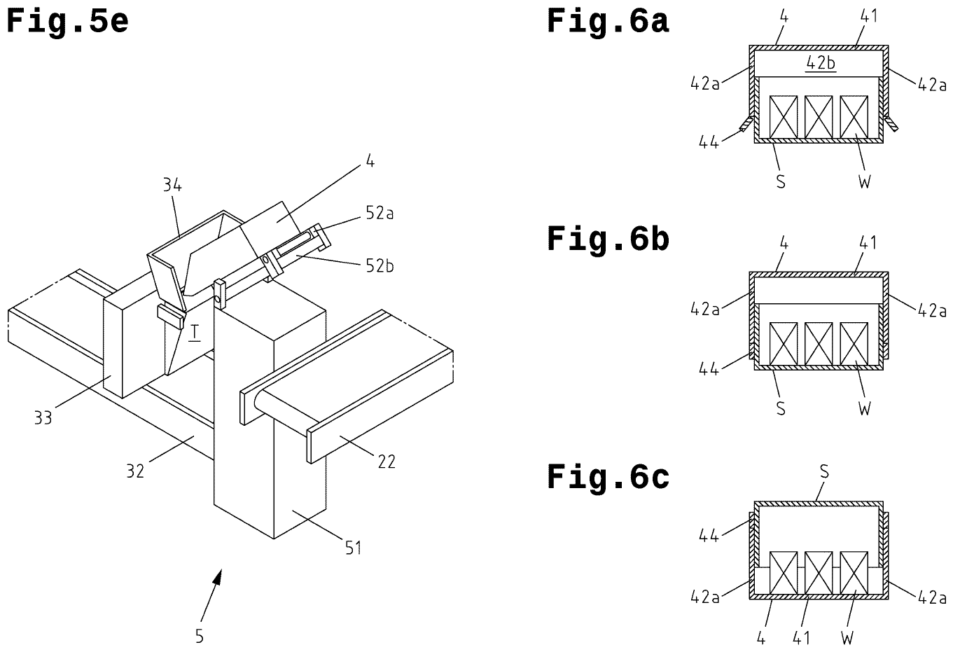

In other words, the dispensing container is surrounded (circumferentially) by the side walls of the transfer container when the transfer container is put over the dispensing container, as can be seen in FIGS. 5b, 5c, 6a, 6b and 6c, for example. Accordingly, the transfer container is configured and adapted in such a way that a dispensing container is received between side walls, in particular the longitudinal side walls and the at least one transverse side wall, when the transfer container is put over the dispensing container.

It is thereby ensured that the article is guided by the side walls of the dispensing container during emptying. The article is prevented from getting stuck or jammed on the side walls of the transfer container or between the side walls of the transfer container and the side walls of the dispensing container S, even when smaller articles are reloaded.

The base of the transfer container can serve to place the article and support the dispensing container. In particular, side walls of the dispensing container can be supported by the base of the transfer container. According to this embodiment, the base of the transfer container forms a placement surface and a support surface that is facing the side walls. The dispensing container comprises a base, the side walls that protrude from the base, and a receiving opening delimited by the side walls. The receiving opening of the dispensing container can be opposite the base.

According to a particularly preferred embodiment, the transfer container is configured as a chute.

In very general terms, containers, in particular the dispensing container and/or the transfer container, can be provided in an upright orientation or upside-down orientation. In the upright orientation, the respective container is oriented with its base to the bottom and the receiving opening to the top, such that the base forms a placement surface for the article. In the upside-down orientation, the respective container is oriented with its base to the top and the receiving opening to the bottom. A container that can be transported on a conveying device, such as the dispensing container, can rest in the upright orientation with the base and/or in the upside-down orientation with upper edges of the side walls on the conveying device.

The dispensing container can be provided at the first provisioning location by the first provisioning device, in particular in the upright orientation. Analogously thereto, the receiving container can be provided at the second provisioning location by the second provisioning device, in particular in the upright orientation.

It is advantageous if the container manipulation device has a first container manipulation unit for handling the transfer container and optionally a second container manipulation unit for handling the dispensing container.

It is thereby advantageous if the first container manipulation unit is configured to put the transfer container, in particular with its receiving opening, over a dispensing container containing an article provided by the first provisioning device and to turn the transfer container together with the dispensing container such that the article is dispensed from the dispensing container into the transfer container.

Furthermore, it is advantageous if the second container manipulation unit is configured to remove the dispensing container from the transfer container.

Furthermore, it is expedient if the first container manipulation unit is configured to move, in particular to tilt, the transfer container such that the article is emptied from, in particular tipped out of, the transfer container, and is dispensed into a receiving container provided by the second provisioning device.

It is expedient if the container manipulation device, in particular the first container manipulation unit, is configured to move the transfer container from a starting position, in which the transfer container is arranged in the upright orientation, into a putting over position, in which the transfer container is arranged in the upside-down orientation. In the putting over position, the transfer container is preferably arranged at the first provisioning location. During putting over in step ii) of the method, the transfer container is preferably brought out of the starting position into the putting over position using the first container manipulation unit.

It is advantageous if the container manipulation device, in particular the first container manipulation unit, is configured to bring the transfer container out of the putting over position into the starting position, whereby the transfer container can be turned together with the dispensing container. During turning in step iii) of the method, the transfer container can thus be brought out of the putting over position into the starting position by the first container manipulation unit. The dispensing container received in the transfer container is thereby turned from the upright orientation into the upside-down orientation, whereby the article is dispensed from the dispensing container into the transfer container.

Furthermore, the container manipulation device, in particular the container manipulation unit, is preferably configured to bring the transfer container out of the starting position into a tipping out position and optionally out of the tipping out position into the starting position. In the tipping out position, the transfer container is tilted vis-à-vis a horizontal plane. In particular, the base of the transfer container and the horizontal plane form a tilt angle of between 0° and 90°. The base of the transfer container is preferably tilted in the tipping out position such that the article slips, slides and/or falls out of the transfer container through the dispensing opening, in particular onto the second provisioning location.

The tilt angle thereby depends in particular on a friction between the base of the transfer container and the article to be dispensed and/or a location of a center of gravity of the article to be dispensed. For instance, the better the article can slip on the base of the transfer container or the lower the coefficient of friction of the article and the base of the transfer container is, the smaller the tilt angle can be configured. According to a particularly preferred embodiment, the base and the horizontal plane form an angle of more than 30°, in particular between 45° and 75°.

To enable a small tilt angle, it can, for example, be provided that the base of the transfer container is provided with a non-stick coating. After the dispensing container has been removed from the transfer container in step iv) and a receiving container has been provided in step v), the article can be tipped out of the transfer container and reloaded into a provided receiving container, in particular in that the transfer container is brought out of the starting position into the tipping out position using the container manipulation device, in particular by the first container manipulation unit. The receiving container is thereby positioned such that when tipped out of the transfer container, the article lands in the receiving container.

Receiving containers are generally provided for shipping to a customer and are therefore preferably made from a recyclable material. Receiving containers can, for example, be shipping boxes or shipping bags. The shipping bags can, for instance, be made of plastic or paper, in particular Kraft paper.

In order to fill an article into the receiving container, the receiving containers generally have one, in particular sealable, receiving opening. At the second provisioning location the receiving containers are preferably provided with an upward-facing receiving opening, i.e. in the upright orientation previously described for the dispensing container and the transfer container, such that the article can be filled from above through the receiving opening.

It is advantageously provided that the transfer device comprises a clamping device that is configured to secure, in particular to fix, the dispensing container in the transfer container. The clamping device can thereby be arranged in particular on the transfer container.

It is advantageous if the dispensing container is secured, in particular is fixed, in the transfer container by the clamping device during step iii) of the method.

It is expedient if the clamping device has clamping elements arranged along the side walls of the transfer container, in particular on an upper edge of the side walls, said clamping elements being adjustable to a dispensing container received in the transfer container in order to secure, in particular to fix, the former. For this purpose, the clamping elements can, for example, be swivelable or be guide-mounted by a curve guide means. It is preferably provided that the transfer container, preferably when viewed from above, is arranged or positionable next to the first provisioning location and/or next to the second provisioning location, in particular between the first and second provisioning location. The transfer container and dispensing container and/or transfer container and receiving container are thereby positioned close to one another spatially, such that on the one hand the transfer container only has to be moved over a short distance for the putting over. On the other hand, this enables a direct tipping out of the article from the transfer container into the receiving container.

It is advantageously provided that the transfer container and/or a support structure of the first container manipulation unit described hereinafter is/are arranged in a stationary manner. Stationary manner is hereby understood such that the transfer container can indeed be tilted, tipped, turned and/or rotated, however cannot be moved away from its location, in particular between the first and second provisioning location, because the transfer container is, for instance, movably mounted on a stationary support structure.

Alternatively, it can be provided that the transfer container and/or the support structure are arranged on a driverless transport vehicle. This allows for the first and second provisioning location to be arranged in a spatially separate manner from one another, for example in different regions of an order-picking system. The driverless transport vehicle can position the transfer container next to the first provisioning location for putting over, and next to the second provisioning location for dispensing the article.

It is expedient if the first container manipulation unit has a support structure on which the transfer container is movably mounted. This support structure can, as previously mentioned, be arranged in a stationary manner or on a driverless transport vehicle. The support structure can, for example, be configured as a carrying mount or carrying frame.

It is preferably provided that the transfer container on the one hand is swivel-mounted about a first swivel axis on the support structure in order to put the transfer container over the dispensing container, and on the other hand is swivel-mounted about a second swivel axis on the support structure in order to tilt the transfer container and dispense the article from the transfer container. It is thereby advantageous if the transfer container can be brought out of the starting position into the putting position and vice versa by swiveling about the first swivel axis, and brought out of the starting position into the tipping position and vice versa by swiveling about the second swivel axis.

It is further advantageous if in step ii) of the method the transfer container is swiveled about the, in particular stationary, first swivel axis and/or in step vi) of the method about the, in particular stationary, second swivel axis.

It can be provided that the first swivel axis and the second swivel axis are identical. The transfer container can be put over the dispensing container by swiveling in a first direction of rotation and be tilted for dispensing by swiveling in a second direction of rotation. The second direction of rotation is counter to the first direction of rotation for this purpose. The transfer container can be mounted on the support structure via a first rotating shaft that extends along the first and second swivel axis.

Alternatively, it can be provided that the first and second swivel axis are arranged at a distance to one another and are aligned parallel or orthogonally to one another. The transfer container can thereby be put over the dispensing container by swiveling it about the first swivel axis in the first direction of rotation and be tilted for dispensing by swiveling about the second swivel axis in the second direction of rotation.

The transfer container can be mounted on the support structure via a first rotating shaft extending along the first swivel axis and a second rotating shaft extending along the second swivel axis.

The first and second swivel axes are preferably aligned parallel to one another. It is thereby expedient if the second direction of rotation is counter to the first direction of rotation. Alternatively, it can be provided that the first and second swivel axes are aligned orthogonally to one another, wherein the second direction of rotation extends orthogonally to the first direction of rotation.

To guarantee reliable tipping out, it is advantageous if the second swivel axis is aligned parallel to the dispensing opening, wherein the dispensing opening preferably extends along one side of the transfer container. In particular, a second swivel axis can extend parallel to the first swivel axis. The first swivel axis and the second swivel axis can extend horizontally.

It is expedient if the first container manipulation unit comprises a first swivel drive to swivel the transfer container about the first swivel axis, and/or comprises a second swivel drive to swivel the transfer container about the second swivel axis.

Preferably, the first swivel axis is configured to drive the first rotating shaft and the second swivel drive is configured to drive the second rotating shaft. If the first swivel axis and the second swivel axis are identical and only one rotating shaft is provided, the first swivel drive is sufficient to swivel the transfer container about the first and second swivel axes. The second swivel drive is thereby not required.

Furthermore, it is advantageous if the first container manipulation unit has a swivel frame that comprises a first swivel unit and a second swivel unit, wherein the first swivel unit is connected with the transfer container and is swivel-mounted about the first swivel axis on the second swivel unit, and wherein the second swivel unit is swivel-mounted about the second swivel axis on the support structure. It is thereby particularly preferably provided that a swivel movement of the first swivel unit about the first swivel axis and counter to the first direction of rotation, in particular in the second direction of rotation, is delimited by the second swivel unit, for instance by the first swivel unit lying on the second swivel unit.

It is advantageously provided that the first container manipulation unit comprises a first rotating shaft extending along the first swivel axis and a second rotating shaft extending along the second swivel axis, wherein the first rotating shaft is connected with the first swivel unit, is swivel-mounted on the second swivel unit and is drivable by the first swivel drive, and wherein the second rotating shaft is connected with the second swivel unit, is swivel-mounted on the support structure and is drivable by the second swivel drive.

To handle the dispensing container and/or the transfer container, in particular to remove the dispensing container from the transfer container, it can be provided that the container manipulation device, in particular the second container manipulation unit, has a gripping unit that is configured to receive the dispensing container and/or the transfer container. The gripping unit can thereby comprise suction grippers and/or clamping grippers, for example.

It is expedient if the container manipulation device comprises a gantry robot or articulated robot.

The container manipulation device can have a second container manipulation unit for handling the dispensing container. The second container manipulation unit can be configured as a gantry robot or articulated robot.

It is advantageously provided that the first provisioning device comprises a conveying device that is configured to transport the dispensing container to the first provisioning location and provide it there.

The conveying device of the first provisioning device can, for example, thereby lead from the picking station to the first provisioning location. Alternatively, it can be provided that the dispensing container is transferred from a conveying device of the order-picking system to the conveying device of the first provisioning device.

It is expedient if in step i) of the method the dispensing container is transported to the first provisioning location, in particular from a picking station of an order-picking system, using a conveying device. This is preferably performed using the conveying device of the first provisioning device.

Furthermore, the first provisioning device can comprise a, in particular automatic, (further) conveying device that is configured to receive and transport away the dispensing container from the container manipulation device, in particular from the second container manipulation unit.

Furthermore, it is expedient if the second provisioning device comprises a, in particular automatic, conveying device that is configured to transport the receiving container away from the second provisioning location.

In addition, it can be provided that the second provisioning device comprises a, in particular automatic, further conveying device that is configured to transport the receiving container to the second provisioning location and provide it there. The conveying device and/or the further conveying device of the first provisioning device and/or second provisioning device can each comprise a stationary conveying device and/or a mobile conveying device. On the one hand, the stationary conveying device can have a continuous conveyor, for example a roller conveyor and/or a belt conveyor. On the other hand, the mobile conveying device can have a non-continuous conveyor, for example a driverless transport system. The driverless transport system can comprise a plurality of driverless transport vehicles, in particular “automated guided vehicles” (for short AGV) and/or “autonomous mobile robots” (for short: AMR).

The conveying devices preferably each form a conveying plane on which containers such as the dispensing container or the receiving container can rest and be transported. These conveying planes can, for example, be provided as conveyor rollers of a roller conveyor, as a conveyor belt of a belt conveyor, as a receiving platform of a transport vehicle, or the like.

As previously mentioned, the dispensing containers can be provided as shipping bags. These shipping bags can, for example, be manufactured by providing a substantially tubular material web and whereby the provisioning device comprises a cutting device that cuts off sections of the material web and seals it at one end to produce bags. The further conveying device of the second provisioning device can thus be provided as a feeding device for feeding the material web.

To provide the receiving containers in an open fashion at the second provisioning location, it is advantageous if the second provisioning location comprises a spreading unit that is configured to spread the receiving container, in particular a shipping bag.

Analogously thereto, it can be provided that the receiving container, in particular the shipping bag, is spread in step v), preferably using the spreading unit.

It is expedient if the second provisioning device comprises a closing device that is configured to close the receiving container. The closing device can, for example, be configured as a box lid applying device or be configured to close, in particular to heat seal, shipping bags.

It is advantageously provided that in step vii) of the method the receiving container is closed after the article has been dispensed into it.

Furthermore, it is advantageous if the second provisioning device has a filling element, in particular a hopper, that is configured to feed the article from the transfer container into the receiving container. It is thereby guaranteed that the article is reliably dispensed into the receiving container and that no articles are lost. Accordingly, the article can be fed through the filling element during dispensing in step vi).

In order to provide a receiving container with optimized fill volume, it can be provided that the transfer device has a computer system, in particular a computer, that is configured to calculate a space requirement of the article in the receiving container based on the article in the dispensing container, in particular based on dimensions of the article in the dispensing container

The computer system can thereby receive a picking order allocated to the dispensing container and/or master data of the article from a warehouse management system. The picking order thereby determines which article, in particular which items, has been loaded into the dispensing container. The master data of the article generally comprise at least a dimension and thus a space requirement of the respective items. A probable space requirement of the article in the receiving container can thus be calculated based on the picking order and/or the master data.

Optionally, the first provisioning device can comprise a camera system to capture an image of the article, wherein the computer system is configured to receive and analyze a captured image in order to calculate the space requirement of the article in the receiving container. An analysis of the image can be performed using an object recognition algorithm, wherein individually recognizable items of the article in the image can be acquired and their dimensions calculated. In particular, the object recognition algorithm can be implemented using artificial intelligence, for example using machine learning, in particular using deep learning.

On the one hand, the dimensions of the items can be calculated by image processing of the captured image. On the other hand, the dimensions can be calculated by identifying the items of the article using image processing and the corresponding master data of the individual items being accessed.

Furthermore, it is preferably provided that the second provisioning device is configured to receive a calculated space requirement from the computer system and to provide a receiving container with a filling volume corresponding to the space requirement.

It can thereby be provided that pre-prepared order containers of different types are present. Order containers of different types thereby differ in particular with respect to their filling volume. Thus, two or three different order container types, such as “small”, “medium” and “large”, can be provided, each having a different filling volume.

Alternatively, it can be provided that the order containers are custom made. For example, a shipping bag can be produced with a maximum filling volume corresponding to the space requirement.

According to a particularly preferred embodiment it is provided that in step i) of the method a space requirement of the article in the receiving container is calculated by using a computer system based on the article in the dispensing container, in particular based on dimensions of the article in the dispensing container, and in step v) of the method a receiving container with a filling volume corresponding to the space requirement is provided.

It is further expedient if the method for reloading articles from a dispensing container into a receiving container is performed with a transfer device as previously described.

The further object is solved using the previously described advantages and effects with an order-picking system of the type mentioned at the beginning, wherein the transfer device is configured according to one of the previously described aspects and the first provisioning device of the transfer device is configured to accept dispensing containers loaded with articles from the third conveying device.

The article storage of the order-picking system is preferably an automatically operated article storage in which articles are stored in storage containers. For this purpose, the article storage preferably comprises a plurality of storage racks for storing the storage containers. For the storage and retrieval of the storage containers, the article storage can further have an automatically operated storage and retrieval unit with single-level storage and retrieval devices or multi-level storage and retrieval devices.

Articles can be reloaded at the picking station according to picking orders from storage containers into dispensing containers, in particular into picking containers. Each picking order is thereby allocated to one or more dispensing containers. Storage containers and dispensing containers can be provided at the picking station for this purpose. The picking station can be configured for automatic or manual picking.

Preferably, the first conveying device of the order-picking system is configured to accept storage containers from the storage and retrieval unit, to provide storage containers at the picking station and/or to transfer storage containers to the storage and retrieval unit. The second conveying device of the order-picking system is preferably configured to transport empty dispensing containers to the picking station and provide them there. The third conveying device is configured to transport dispensing containers filled with articles from the picking station to the transfer station. For this purpose, the third conveying device connects (in a conveying technology sense) to the second conveying device. The dispensing containers can be transfered from the third conveying device to the first conveying device of the transfer device, in particular to the conveying device of the first provisioning device.

Thus, the article picked according to the picking order can be automatically transported from the picking station to the transfer device and automatically be reloaded by the transfer device into a receiving container, in particular into a shipping bag or similar.

The conveying devices of the order-picking system can each comprise a stationary conveying device and/or a mobile conveying device. On the one hand, the stationary conveying device can have a continuous conveyor, for example a roller conveyor and/or a belt conveyor. On the other hand, the mobile conveying device can have a non-continuous conveyor, for example a driverless transport system. The driverless transport system can comprise a plurality of driverless transport vehicles, in particular “automated guided vehicles” (for short AGV) and/or “autonomous mobile robots” (for short: AMR).

For a better understanding of the invention, it is explained in more detail with reference to the following figures.

These show in highly simplified, schematic representation:

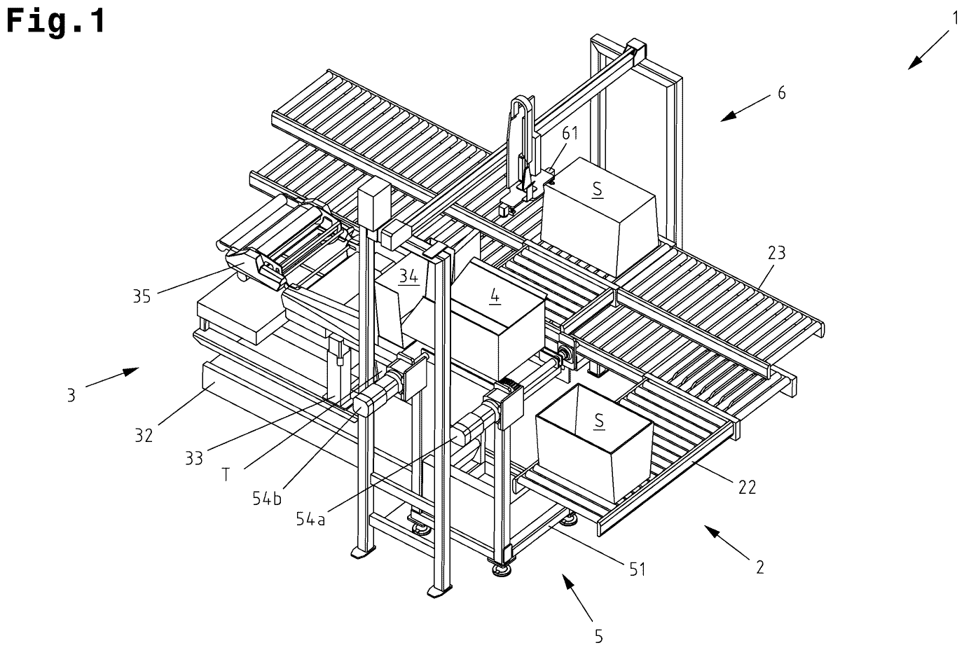

FIG. 1 a perspective view of a transfer device;

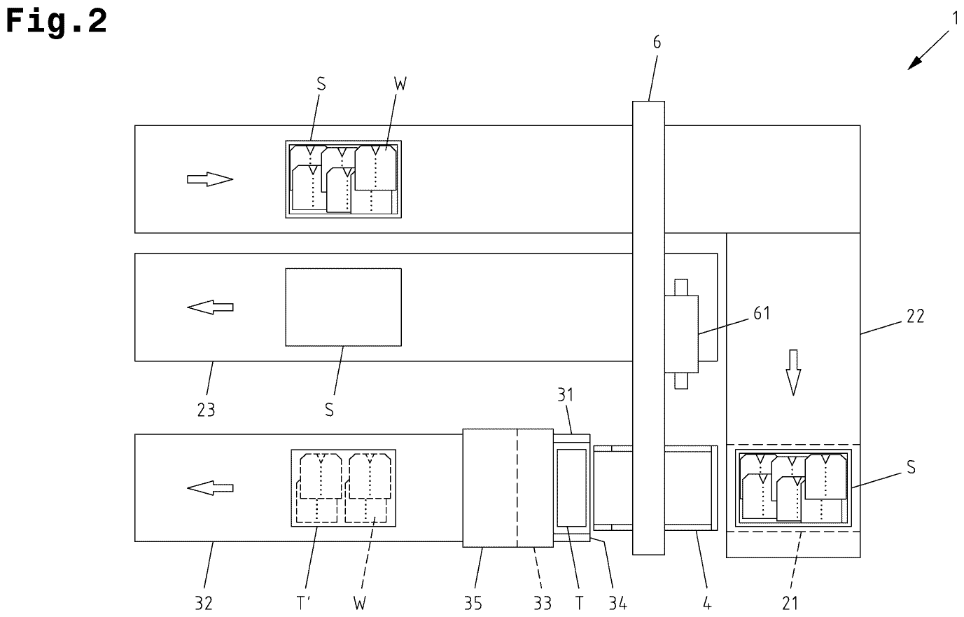

FIG. 2 a top view of the transfer device;

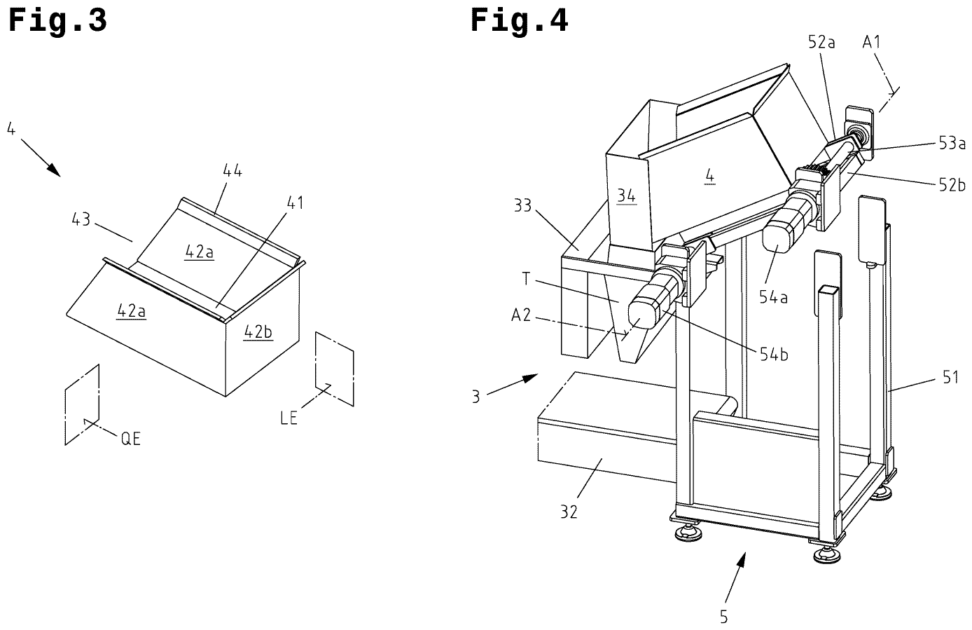

FIG. 3 a transfer container;

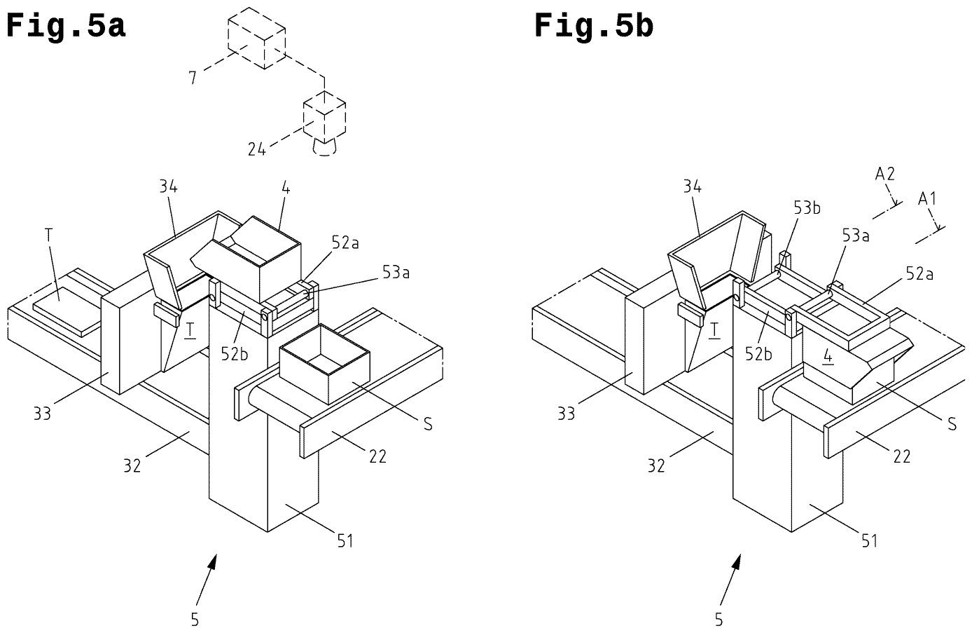

FIG. 4 a first container manipulation unit of the transfer device;

FIG. 5a to 5e the transfer device for reloading articles in different method steps;

FIG. 6a to 6c a dispensing container and a transfer container put over the dispensing container, shown in cross section;

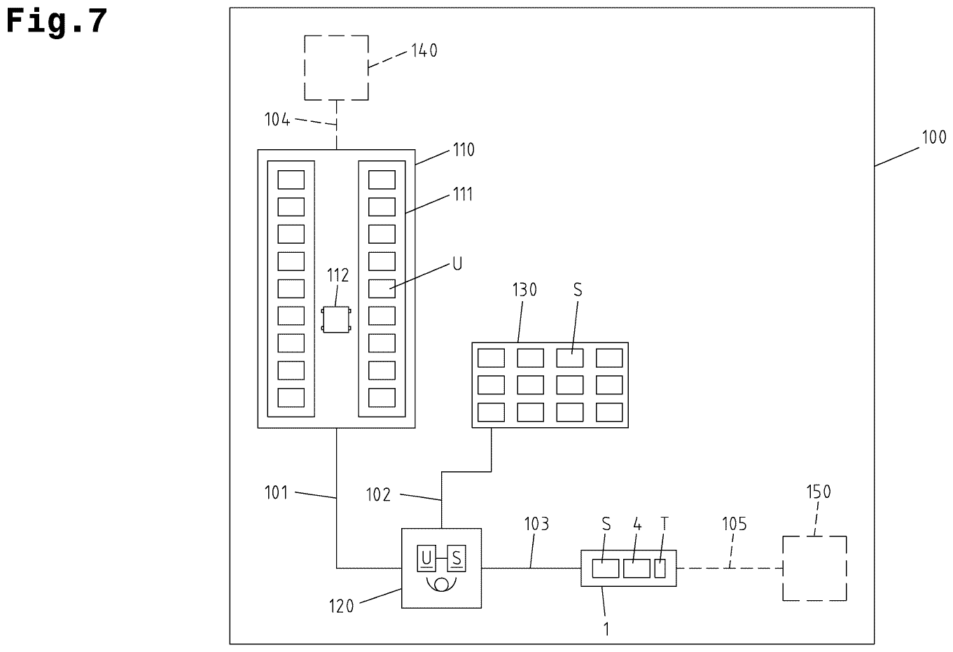

FIG. 7 an order-picking system.

It is worth noting here that the same parts have been given the same reference numerals or same component configurations in the embodiments described differently, yet the disclosures contained throughout the entire description can be applied analogously to the same parts with the same reference numerals or the same component configurations. The indications of position selected in the description, such as above, below, on the side etc. refer to the figure directly described and shown, and can be applied in the same way to the new position should the position change.

FIG. 1 shows a perspective view of a transfer device 1. FIG. 2 shows a schematic representation of the transfer device 1, whereby for the sake of clarity the conveying devices 22, 23 are shown adjacent to one another. As can be seen in FIG. 1, the conveying devices 22, 23 can be arranged one above the other.

The transfer device 1 has a first provisioning device 2 for the provision of dispensing containers S and a second provisioning device 3 for the provision of receiving containers T. The transfer device 1 further comprises a transfer container 4 and a container manipulation device. The container manipulation device has, for example, a first container manipulation unit 5 and a second container manipulation unit 6.

The first provisioning device 2 forms a first provisioning location 21 where a dispensing container S can be provided, as shown in FIG. 1 and FIG. 2. For the transportation of the dispensing container S to the first provisioning location 21, the first provisioning device 2 preferably comprises a conveying device 22. To transport emptied dispensing containers S away, the first provisioning device 2 can further have an optional further conveying device 23.

A dispensing container S generally comprises a base and side walls protruding from the base. The dispensing container S is open on an upper side opposite the base. The dispensing container S is preferably configured as a crate or box.

FIG. 1 shows a dispensing container S provided at the first provisioning location 21, which, as shown by way of example in FIG. 2, contains an article W. The article is not shown in FIG. 1. The dispensing container S is aligned in an upright orientation where the base is to the bottom and the upper side to the top. The base thus lies on the conveying device 22.

Furthermore, FIG. 1 shows an emptied dispensing container S on the further conveying device 23. This dispensing container S is aligned in an upside-down orientation where the base 41 is to the top and the upper side to the bottom. The dispensing container S thereby rests with upper edges of the side walls on the further conveying device 23.

The second provisioning device 3 forms a second provisioning location 31 where a dispensing container T can be provided, as shown in FIG. 1 and FIG. 2. The second provisioning device 3 preferably comprises a conveying device 32 to transport receiving containers T (denoted as T′ in FIG. 2) loaded with articles W away from the second provisioning location 31. In order to provide an unfilled receiving container (denoted as T in FIG. 2) in an open manner, the second provisioning device 3 can comprise a spreading unit 33, for instance to spread shipping bags. Such shipping bags can be polybags or paper sacks, for example. The second provisioning device 3 can also comprise a preferably automatic feeding device 35 (as represented schematically in FIGS. 1 and 2) that can provide (unfilled) receiving containers T and feed them to the spreading unit 33. So that items that are dispensed from the transfer container 4 can be guided into the receiving container T, the second provisioning device 3 can comprise a filling element 34, in particular a hopper. The filling element 34 is preferably arranged above the second provisioning location 31. The receiving container T can thus be provided below the filling element 34.

As is shown by way of example in FIG. 1, the transfer container 4 can be swivel-mounted on the first container manipulation unit 5, wherein the first container manipulation unit 5 is arranged or is arrangeable between the first provisioning location 21 and the second provisioning location 31. That thereby enables the transfer container 4 to be put over the dispensing container S by swiveling in a first direction, and to be emptied by swiveling in a second direction.

The second container manipulation unit 6 preferably comprises a gripping unit 61 that is configured to lift the dispensing container S. For this purpose, the second container manipulation unit 6 can be configured as a gantry robot, for instance. Alternatively, it is, however, also conceivable that the second container manipulation unit 6 is configured as an articulated robot.

FIG. 3 shows the transfer container 4 that comprises a base 41 as well as side walls 42a, 42b protruding from the base 41. The side walls 42a, 42b delimit a receiving opening opposite the base 41, through which the dispensing container S can be received in the transfer container 4. T

he side walls 42a, 42b expediently comprise two opposing longitudinal side walls 42b that extend parallel to a longitudinal center plan LE of the transfer container 4, and optionally a transverse side wall 42b that extends parallel to a transverse center plane QE.

A dispensing opening 43 is arranged between the longitudinal side walls 42b, in particular on an edge of the base 41 opposite the transverse side wall 42, through which opening an article W can be tipped out of the transfer container 4. The dispensing opening 43 is aligned in particular parallel to the transverse center plane QE.

Optionally, the side walls 42a, 42b can have a further transverse side wall opposite the described transverse side wall 42b that also extends parallel to the transverse center plane QE and in which the dispensing opening 43 is arranged.

As shown in FIG. 3, the transfer container 4 can be aligned in an upright orientation in which the base 41 is to the bottom and the receiving opening to the top. Alternatively, the transfer container 4 can be aligned in an upside-down orientation in which the base 41 is to the top and the receiving opening to the bottom.

To secure the dispensing container S in the transfer container 4, the transfer container 4 can comprise a clamping device having a plurality of clamping elements 44 that can be brought into contact with a dispensing container S received in the transfer container 4. The clamping elements 44 are arranged on an upper edge of the side walls 42a, 42b facing away from the base 41 of the transfer container 4.

The clamping elements 44 of the clamping device can thereby be arranged on the longitudinal side walls 42b and be mounted movably, in particular pivotably, towards to the longitudinal center plane LE on the respective longitudinal side wall 42a. Furthermore, one or more clamping elements 44 of the clamping device can be arranged on the transverse side wall 42band be mounted movably, in particular pivotably, towards the transverse center plane QE on the transverse side wall 42b. In case the additional transverse side wall is provided, one or more clamping elements 44 of the clamping device can be arranged on it in the same way.

FIG. 4 shows an exploded view of the first container manipulation unit 5 with the swivel-mounted transfer container 4 thereon.

As can be seen in FIG. 1 and FIG. 4, the first container manipulation unit 5 can comprise a support structure 51 on which the transfer container 4 is swivel-mounted. The support structure 51 and/or the transfer container 4 are preferably arranged between the first provisioning location 21 and the second provisioning location 31. The support structure 51 can, as shown in FIG. 1, be arranged in a stationary manner or on a driverless transport vehicle.

The transfer container 4 is swivelable from a starting position shown in FIG. 1 into a tipping out position shown in FIG. 4, as well as into a putting over position as shown in the following FIG. 5b. For this purpose, the transfer container 4 is preferably mounted on the support structure 51 by means of a swivel frame.

The swivel frame preferably comprises a first swivel unit 52a and a second swivel unit 52b. The first swivel unit 52a is swivel-mounted about the first swivel axis A1 on the second swivel unit 52b. Furthermore, the second swivel unit 52b is swivel-mounted about the second swivel axis A2 on the support structure 51. By swiveling the transfer container 4 in a first direction of rotation about the first swivel axis, it can thus be brought out of the starting position into the putting over position. Analogously thereto, the transfer container 4 can be brought out of the starting position into the tipping out position by swiveling in a second direction of rotation about the second swivel axis.

Furthermore, it can be provided that the first container manipulation unit 5 comprises a first rotating shaft 53a that extends along the first swivel axis A1. The first rotating shaft 53a can be connected with the first swivel unit 52a and be rotatably mounted on the support structure 51 or, as in FIG. 4, on the second swivel unit 52b. It is expedient if the first rotating shaft 53a is connected with and drivable by a first swivel drive 54a. The first swivel drive 54a can, as shown in FIG. 1 and FIG. 4, be mounted on the second swivel unit 52b.

It can further be provided that the first container manipulation unit 5 comprises a second rotating shaft 53b that extends along the second swivel axis A2 in order to tilt the container in a second direction, in particular to tip the container or bring it into the tipping out position shown. The second rotating shaft 53b can be connected with the second swivel unit 52b and, as shown in FIG. 4, be rotatably mounted on the support structure 51. It is expedient if the second rotating shaft 53b is connected with and drivable by a second swivel drive 54b.

Preferably, a swivel movement of the first swivel unit 52a is restricted in the second direction of rotation, for example by the second swivel unit 52b. For this purpose, it can be provided that the first swivel unit 52a rests on the second swivel unit 52b in the starting position and in the tipping out position.

To receive an article W in the transfer container 4, the latter can be arranged in the starting position in which the transfer container 4 is aligned in the upright orientation. In the starting position, the base 41 of the transfer container 4 is aligned substantially horizontally. The starting position is shown in FIG. 1 as well as in the following FIGS. 5a, 5c and 5d.

By swiveling the transfer container 4 in the first direction of rotation about the first swivel axis A1, the transfer container 4 can be brought out of the starting position into the putting over position, in which the transfer container 4 is aligned in the upside-down orientation. This is shown by way of example in FIG. 5b.

Furthermore, the transfer container 4 can be brought out of the starting position into the tipping out position by swiveling the transfer container 4 in the second direction of rotation about the second swivel axis A2, which enables the article W to be tipped out through the dispensing opening 43. The tipping out position is shown by way of example in FIG. 4 as well as in the following FIG. 5e.

The second provisioning device 3 is shown in a highly simplified manner in FIG. 4, where it provides a receiving container T, in particular a shipping bag. For this purpose, the second provisioning device 3 can comprise a spreading unit 33 that is configured to spread the receiving container T such that it is held open.

In addition, the optional filling element 34, which can, for example, be configured as a hopper, can be seen in FIG. 4.

FIG. 5a to 5e show simplified representations of the transfer device 1. The method for reloading an article W from the dispensing container S into the receiving container T is described in the following with reference to these representations.

The simplified representation shows the first and second provisioning device 2, 3, the transfer container 4 and the first container manipulation unit 5 of the transfer device 1. For the sake of clarity, the second container manipulation unit 6 and the optional additional conveying device 23 of the first provisioning device 2 are only depicted in FIG. 5d. Moreover, for the sake of clarity the article W is not depicted in FIG. 5a to 5e.

The support structure 51 of the first container manipulation unit 5 is also shown in a highly simplified representation in FIG. 5a to 5e. As previously described, the swivel frame comprising the first swivel unit 52a and the second swivel unit 52b is mounted on the support structure 51. Furthermore, the optional filling element 34 of the second provisioning device 3 is also represented.

In FIG. 5a, the transfer device 4 is arranged in the starting position.

According to a method for reloading an article W from the dispensing container S into a receiving container T, in step i) a dispensing container S containing an article W is first provided at the first provisioning location 21, as is shown in FIG. 5a as well as in FIG. 1 and FIG. 2. For this purpose, the dispensing container S can be transported to the first provisioning location 21 using the conveying device 22 of the first provisioning device 2. The dispensing container S is provided in an upright orientation.

Furthermore, FIG. 5a shows a filled and closed receiving container T from a preceding performance of the method on the conveying device 32 of the second provisioning device 3. In a subsequent step ii), the transfer container 4 is put over the dispensing container S, whereby the dispensing container S is received in the former through the receiving opening of the transfer container 4. This can be done by swiveling the transfer container 4 in the first direction of rotation about the first swivel axis A1, thus bringing it out of the starting position into the putting over position, as shown in FIG. 5b. For this purpose, the first rotating shaft 53a can be driven by the first swivel drive 54a, not shown in FIG. 5a to 5e.

As can be seen in FIG. 5b, the first swivel unit 52a is swiveled in the first direction of rotation about the first swivel axis A1 relative to the second swivel unit 52b, whereby the transfer container 4 is brought out of the starting position into the putting over position.

Optionally, the dispensing container S can be secured in the transfer container 4 by the clamping device. The clamping device is not shown in FIG. 5a to 5e, although such a device is preferably provided.

In step iii), the transfer container 4 is turned together with the dispensing container S, such that the transfer container 4 is brought out of the putting over position into the starting position, as shown in FIG. 5c. This is preferably performed by swiveling the transfer container 4 counter to the first direction of rotation about the first swivel axis A1. For this purpose, the first rotating shaft 53a can in turn be driven by the first swivel drive 54a. The dispensing container S is thereby turned out of the upright orientation into the upside-down orientation, such that the article W is dispensed from the dispensing container S into the transfer container 4. The article W is now in the transfer container 4. The clamping device can now be released again if the transfer container 4 was previously secured by it.

In step iv), the dispensing container S is subsequently removed from the transfer container 4 by the second container manipulation unit 6. The dispensing container S can thereby be received by the gripping unit 61, for example, and optionally dispensed onto the conveying device 23 of the first provisioning device 2, as is shown by way of example in FIG. 5d.

In step v), a receiving container T is provided at the second provisioning location 31 using the second provisioning device 3. Step v) is performed prior to the subsequent step vi) and can be performed simultaneously or temporally overlapping with steps i) to iv), as is indicated by the provided receiving container T in FIG. 5a to 5e. In the example shown, the receiving container T is provided as a shipping bag that is spread by the spreading unit 33 at the provisioning location.

Finally, in step vi) the article W is dumped into the receiving container T as shown in FIG. 5e by positioning and aligning, in particular by tipping, the transfer container 4 accordingly about the second swivel axis A2. For this purpose, the transfer container 4 is brought out of the starting position into the previously described tipping out position.

The second swivel unit 52b is swiveled together with the first swivel unit 52a about the second swivel axis A2, whereby the transfer container 4 is brought into the tipping out position. The first swivel unit 52a thereby preferably rests on the second swivel unit 52b.

Optionally, in step vii) the receiving container T can be closed, in particular using a closing unit of the second provisioning device 3, and/or dispensed to the conveying device 32 of the second provisioning device 3.

The filled and closed receiving container T can be transported away from the second provisioning location 31 with the conveying device 32 of the second provisioning location 3, as shown by way of example in FIG. 5a. The receiving container T can, in particular, be transported to a shipping station of an order-picking system 100 or be transferred to a subsequent conveying device not shown here.

To package the article W with an optimized filling volume, it can be provided that the transfer device 1 comprises a computer system 7 that is configured to calculate a space requirement of the article W in the receiving container T based on the article W in the dispensing container S. The computer system 7 is depicted by way of example in FIG. 5a. The second provisioning location 3 is thereby preferably configured to receive a calculated space requirement from the computer system 7 and to provide a receiving container T with a filling volume corresponding to the space requirement.

Furthermore, it can be provided that the first provisioning device 2 comprises an optional camera system 24 that is configured to capture an image of the article W in the dispensing container S and to transmit that image to the computer system 7. The space requirement can thereby be calculated based on the captured image.

FIG. 6a to 6c show the transfer container 4 with a dispensing container S received therein in cross section, whereby the base 41 and the longitudinal side walls 42b are visible.

In FIG. 6a the transfer container 4 is arranged in the putting over position and is put over the dispensing container S. This thus shows a state as is present after step ii). The transfer container 4 is thereby aligned in the upside-down orientation and the dispensing container S in the upright orientation, whereby the article W is received in the dispensing container S.

To secure the dispensing container S in the transfer container 4, the clamping elements 44 of the clamping device can be brought into contact with the dispensing container, in particular in steps ii) and/or iii), as shown in FIG. 6b. The transfer container 4 is thereby secured by clamping and/or fixed relative to the base 41 of the transfer container 4. For this purpose, the clamping elements 44 arranged on the longitudinal side walls 42a are moved in the direction of the longitudinal center plane LE. Analogously thereto, the clamping element 44 or the clamping elements 44 arranged on the transverse side wall 42b or the transverse side walls 42b are moved in the direction of the transverse center plane QE.

As previously described, the transfer container 4 is turned together with the dispensing container S in step iii) of the method. This is shown by FIGS. 6b and 6c viewed together. After turning, the transfer container 4 is in the upright orientation and the dispensing container S in the upside-down orientation. The article W is thereby dispensed through the open upper side of the dispensing container S to the transfer container 4. As can be seen in FIG. 6c, the article W is then in the transfer container 4.

The clamping device can now be released by moving the clamping elements 44 away from the dispensing container S. This is not explicitly shown. When the clamping device is released, the dispensing container S can be removed from the transfer container 4 as previously described with reference to FIG. 5d.

FIG. 7 is a schematic representation of an order-picking system 100 with transfer device 1.

The order-picking system 100 comprises an article storage 110 that preferably has a plurality of storage racks 111 for storing storage containers U as well as an automated storage and retrieval unit. The storage and retrieval unit can have at least one storage and retrieval device 112, in particular several single-level storage and retrieval devices.

Furthermore, the order-picking system 100 comprises a picking station 120 at which articles W can be automatically and/or manually picked according to picking orders from storage containers U into dispensing containers S. Storage containers U and dispensing containers S can be provided at the picking station 120, as shown by way of example in FIG. 7.

The order-picking system 100 optionally has a dispensing container storage 130 where empty dispensing containers S can be held intermediately and/or stored.

Furthermore, the order-picking system 100 can comprise an article receipt 140, in particular a receiving station, where delivered articles W can be received and optionally transported into the article storage 110 for storage.

The order-picking system 100 preferably comprises an article issue 150, in particular a shipping station, where articles W, in particular receiving containers T, are prepared for shipping and/or transferred to a delivery vehicle, for instance.

The article storage 110 and the picking station 120 are connected in a conveying technology sense via a conveying device 101 that is configured to transport storage containers from the article storage 110 to the picking station 120.

Furthermore, a conveying device 102 is provided that is configured to transport dispensing containers S, in particular from the dispensing container storage 130, to the picking station 120. Preferably, the dispensing container storage 130 and the picking station 120 are connected in a conveying technology sense by the conveying device 102.

Moreover, the picking station 120 and the transfer device 1 are connected in a conveying technology sense via a conveying device 103 that is configured to transport dispensing containers S from the picking station 120 to the transfer device 1.

Finally, the article storage 110 is connected via a conveying device 104 with the optional article receipt 140 and/or the transfer device 1 via a conveying device 105 with the optional shipping station. The conveying device 104 is thereby configured to transport storage containers U from the article receipt 140 to the article storage 110. The conveying device 105 is configured to transport receiving containers T from the transfer device 1 to the shipping station. The conveying device 105 is thereby connected in a conveying technology sense to the conveying device 32 of the second provisioning device 3 of the transfer device 1.

Finally, it should be noted that the scope of protection is defined by the patent claims. The description and the drawings should, however, be consulted when construing the claims. Individual features or combinations of features from the various example embodiments as shown and described can constitute separate inventive solutions.

In particular, it should be noted that in reality the represented devices can comprise more or fewer components than shown. The represented devices and their components can partially also be shown not to scale and/or in magnification and/or shrunk down.

### List of Reference Numbers

1 Transfer device
2 First provisioning device
21 First provisioning location
22, 23 Conveying device
24 Camera system
3 Second provisioning device
31 Second provisioning location
32 Conveying device
33 Spreading unit
34 Filling element
35 Feeding device
4 Transfer container
41 Base
42a Longitudinal side wall
42b Transverse side wall
43 Dispensing opening
44 Clamping element
5 First container manipulation unit
51 Support structure
52a, 52b Swivel unit
53a, 53b Rotating shaft
54a, 54b Swivel drive
6 Second container manipulation unit
61 Gripping unit
7 Computer system
100 Order-picking system
101 . . . 105 Conveying device
110 Article storage
111 Storage rack
112 Storage and retrieval unit
120 Picking station
130 Dispensing container storage
140 Article receipt
150 Article issue
A1, A2 Swivel axis
LE Longitudinal center plane
QE Transverse center plane
S Dispensing container
T Receiving container
U Storage container
W Article

1. A transfer device (1) for reloading an article (W) from a dispensing container (S) into a receiving container (T), in particular into a shipping box or shipping bag, comprising
a first provisioning device (2) with a first provisioning location (21) for the provision of a dispensing container (S),
a second provisioning device (3) with a second provisioning location (31) for the provision of a receiving container (T),
a transfer container (4) for the interim receipt of the article (W), and
a container manipulation device for handling the transfer container (4) and the dispensing container (S),
wherein
the transfer container (4) has a base (41), a receiving opening opposite the base (41), side walls (42a, 42b) protruding from the base (41) and delimiting the receiving opening, and a dispensing opening (43), and, in particular, which is configured such that a dispensing container (S) can be received between the side walls (42a, 42b), and
the container manipulation device is configured
to put the transfer container (4) over a dispensing container (S) containing an article (W) provided by the first provisioning device (2) and to turn the transfer container

(4) together with the dispensing container (S) such that the article (W) is dispensed from the dispensing container (S) into the transfer container (4),
to remove the dispensing container (S) from the transfer container (4), and
to move the transfer container (4) such that the article (W) is emptied from the transfer container (4) through the dispensing opening (43) and is dispensed into a receiving container (T) provided by the second provisioning device (3).

2. The transfer device (1) according to claim 1, further comprising a clamping device that is configured to secure the dispensing container (S) in the transfer container (4).

3. The transfer device (1) according to claim 1, wherein the transfer container (4) is arranged or is positionable next to the first provisioning location (21) and/or next to the second provisioning location (31), in particular between the first and second provisioning location (31).

4. The transfer device (1) according to claim 1, wherein the transfer container is arranged in a stationary manner or is arranged on a driverless transport vehicle.

5. The transfer device (1) according to claim 1, wherein the container manipulation device has a first container manipulation unit (5) for handling the transfer container (4) and optionally a second container manipulation unit (6) for handling the dispensing container (S).

6. The transfer device (1) according to claim 5, wherein the first container manipulation unit (5) has a support structure (51), on which the transfer container (4)
is swivel-mounted about a first swivel axis (A1) in order to put the transfer container (4) over the dispensing container (S), and
is swivel-mounted about a second swivel axis (A2), in order to tilt the transfer container (4) and dispense an article (W) from the transfer container (4).

7. The transfer device (1) according to claim 6, wherein the second swivel axis (A2) is aligned parallel to the dispensing opening (43), wherein the dispensing opening (43) preferably extends along one side of the transfer container (4).

8. The transfer device (1) according to claim 6 or 7, wherein the first manipulation unit (5)
comprises a first swivel drive (54a) to swivel the transfer container (4) about the first swivel axis (A1), and/or
comprises a second swivel drive (54b) to swivel the transfer container (4) about the second swivel axis (A2).

9. The transfer device (1) according to claim 6, wherein the first container manipulation unit (5) has a swivel frame that comprises a first swivel unit (52a) and a second swivel unit (52b), wherein the first swivel unit (52a) is connected with the transfer container (4) and is swivel-mounted about the first swivel axis (A1) on the second swivel unit (52b), and wherein the second swivel unit (52b) is swivel-mounted about the second swivel axis (A2) on the support structure (51).

10. The transfer device (1) according to claim 8, wherein the first container manipulation unit (5) comprises a first rotating shaft (53a) extending along the first swivel axis (A1) and a second rotating shaft (53b) extending along the second swivel axis (A2), wherein the first rotating shaft (53a) is connected with the first swivel unit (52a), is swivel-mounted on the second swivel unit (52b) and is drivable by the first swivel drive (54a), and wherein the second rotating shaft (53b) is connected with the second swivel unit (52b), is swivel-mounted on the support structure (51) and is drivable by the second swivel drive (54b).

11. The transfer device (1) according to claim 1, wherein the container manipulation device has a gripping unit (61) that is configured to receive the dispensing container (S) and/or the transfer container (4).

12. The transfer device (1) according to claim 1, wherein the container manipulation device comprises a gantry robot or an articulated robot.

13. The transfer device (1) according to claim 5, wherein the container manipulation device has a second container manipulation unit (6) for handling the dispensing container (S) and optionally is configured as a gantry robot or articulated robot.

14. The transfer device (1) according to claim 1, wherein the first provisioning device (2) comprises a conveying device (22) that is configured to transport the dispensing container (S) to the first provisioning location (21) and provide the dispensing container (S) there.

15. The transfer device (1) according to claim 1, wherein the second provisioning device (3) comprises a conveying device (32) that is configured to transport the dispensing container (T) away from the second provisioning location (31).

16. The transfer device (1) according to claim 1, wherein the second provisioning device (3) comprises a spreading unit (33) that is configured to spread the receiving container (T), in particular a shipping bag.

17. The transfer device (1) according to claims claim 1, wherein the second provisioning device (3) comprises a closing device that is configured to close the receiving container (T).

18. The transfer device (1) according to claims claim 1, wherein the second provisioning device (3) has a filling element (34), in particular a hopper, that is configured to guide the article (W) from the transfer container (4) into the receiving container (T).

19. The transfer device (1) according to claim 1, further comprising a computer system (7) that is configured to calculate a space requirement of the article (W) in the receiving container (T) based on the article (W) in the dispensing container (S), in particular based on dimensions of the article (W) in the dispensing container (S).

20. The transfer device (1) according to claim 19, wherein the first provisioning device (2) comprises a camera system (24) to capture an image of the article (W) in the dispensing container (S), wherein the computer system (7) is configured to receive and analyze a captured image in order to calculate the space requirement of the article (W) in the receiving container (T).

21. The transfer device (1) according to claim 19, wherein the second provisioning device (3) is configured to receive a calculated space requirement from the computer system (7) and to provide a receiving container (T) with a filling volume corresponding to the space requirement.

22. A method for reloading an article (W) from a dispensing container (S) into a receiving container (T) using the transfer device (1), according to claim 1, comprising the steps:
i) providing a dispensing container (S) containing an article (W) at the transfer device (1) using a first provisioning device (2) at a first provisioning location (21);
ii) putting a transfer container (4) over the provided dispensing container (S) using a container manipulation device;
iii) turning of the transfer container (4) together with the dispensing container (S) using the container manipulation device, wherein the article (W) is dispensed from the dispensing container (S) into the transfer container (4);
iv) removing the dispensing container (S) from the transfer container (4) using the container manipulation device;
v) providing a receiving container (T) at the transfer device (1) using a second provisioning device (3) at a second provisioning location (31);
vi) positioning the transfer container (4) using the container manipulation device in such a way that the article (W) is emptied from, in particular tipped out of, the transfer container (4) through a dispensing opening (43) of the transfer container (4), and is dispensed into the receiving container (T).

23. The method according to claim 22, wherein during step iii) the dispensing container (S) is secured, in particular fixed, in the transfer container (4) by a clamping device of the transfer device (1), in particular using clamping elements (44) of the clamping device.

24. The method according to claim 22, wherein in step ii) the transfer container (4) is swiveled about a first swivel axis (A1) and/or in step vi) the transfer container (4) is swiveled about a second, in particular stationary, swivel axis (A2).

25. The method according to claim 22, wherein in step i) the dispensing container (S) is transported to the transfer device (1), in particular from a picking station (120) of an order-picking system (100), using a conveying device (103).

26. The method according to claim 22, wherein in step v) the receiving container (T), in particular a shipping bag, is spread, preferably using a spreading unit (33).

27. The method according to claim 22, comprising the step:
vii) closing the receiving container (T) after the article (W) has been dispensed into it the receiving container (T).

28. The method according to claim 22, wherein
in step i) a space requirement of the article (W) in the receiving container (T) is calculated using a computer system (7) based on the article (W) in the dispensing container (S), in particular based on dimensions of the article (W) in the dispensing container (S), and
in step v) a receiving container (T) with a filling volume corresponding to the space requirement is provided.

29. The method according to claim 22, wherein the transfer container (4) has a base (41), a receiving opening opposite the base (41), side walls (42a, 42b) protruding from the base (41) and delimiting the receiving opening, and the dispensing opening (43), and is configured such that a dispensing container (S) is received between the side walls (42a, 42b) if the transfer container (4) has been put over the dispensing container (S).

30. An order-picking system (100) for picking articles (W) according to picking orders, comprising
an article storage (110) for storing articles (W) in storage containers (U),
a picking station (120) for reloading articles (W) from storage containers (U) into dispensing containers(S), in particular picking containers,
a transfer device (1) for reloading articles (W) from dispensing containers(S) into receiving containers (T), in particular shipping containers,
an automatic first conveying device (101) for transporting storage containers (U) from the article storage (110) to the picking station (120),
an automatic second conveying device (102) for transporting empty dispensing containers(S) to the picking station (120), and
an automatic third conveying device (103) for transporting dispensing containers (S) loaded with articles (W) from the picking station (120) to the transfer device (1),
wherein
the transfer device (1) is configured according to claim 1, and the first provisioning device (2) of the transfer device (1) is configured to receive dispensing containers(S) loaded with articles (W) from the third conveying device (103).
